(19) United States
(12) Patent Application Publication
(10) Pub. No.: US 2025/0390454 A1
(43) Pub. Date: Dec. 25, 2025

(54) COMPUTING DEVICE FOR ACCESSING MEMORY EXPANDER USING CXL INTERCONNECT AND OPERATING METHOD THEREOF

(71) Applicant: Panmnesia Inc., Daejeon (KR)

(72) Inventors: Dong Hyun GOUK, Daejeon (KR); Eo Jin RYU, Daejeon (KR); Sang Won Lee, Daejeon (KR); Dong Pyung KIM, Seongnam-si (KR)

(21) Appl. No.: 18/925,147

(22) Filed: Oct. 24, 2024

(30) Foreign Application Priority Data
Jun. 20, 2024 (KR) 10-2024-0080351

(51) Int. Cl. G06F 13/40; G06F 13/42

(52) U.S. Cl. CPC G06F 13/4022; G06F 13/404; G06F 13/4221

(57) ABSTRACT

Disclosed are a computing device for accessing a memory expander using a compute express link (CXL) interconnect and an operating method thereof. The computing device may include a processor, a memory, and a root complex configured to be connected with the processor, the memory, and a memory expander. The processor may recognize whether the memory expander is connected to the root complex. The processor may update a physical address space of the computing device based on a recognition that the memory expander is connected to the root complex.

### CROSS-REFERENCE TO RELATED APPLICATION

This application claims the benefit of Korean Patent Application No. 10-2024-0080351 filed on Jun. 20, 2024, in the Korean Intellectual Property Office, the entire disclosure of which is incorporated herein by reference for all purposes.

### BACKGROUND

### 1. Field of the Invention

The following disclosure relates to a computing device for accessing a memory expander using a CXL interconnect and an operating method thereof.

### 2. Description of the Related Art

A graphics processing unit (GPU) may be a parallel processing semiconductor capable of processing large amounts of data at once. Recently, due to the parallel processing method of GPUs, GPUs are emerging as a core component of artificial intelligence (AI). GPUs have more cores than central processing units (CPUs) and, for example, include hundreds to thousands of cores to process a large amount of information at once. However, in processing a large amount of information through GPUs, the GPUs may have an issue of insufficient memory capacity. That is, an insufficient memory capacity of GPUs may lead to issues such as failure to run applications such as large-scale AI or reduced application performance. Such issues may occur not only in GPUs, but also in accelerators such as neural processing units (NPUs) and/or tensor processing units (TPUs).

The above description is information the inventor(s) acquired during the course of conceiving the present disclosure, or already possessed at the time, and is not necessarily art publicly known before the present application was filed.

### SUMMARY

An embodiment may provide a technique for allowing a computing device (e.g., a graphics processing unit (GPU), a neural processing unit (NPU), and/or a tensor processing unit (TPU)) to directly access a memory expander to read data stored in the memory expander or write data to the memory expander, without the intervention of a host device (e.g., a central processing unit (CPU)).

However, the technical goals are not limited to those described above, and other technical goals may be present.

According to an aspect, there is provided a computing device including a processor, a memory, and a root complex configured to be connected with the processor, the memory, and a memory expander. The processor may be configured to recognize whether the memory expander is connected to the root complex, and update a physical address space of the computing device based on a recognition that the memory expander is connected to the root complex.

The root complex may be configured to connect the processor, the memory, and the memory expander through a compute express link (CXL) protocol-based interconnect.

The root complex may include a root port configured to be connected with the memory expander, and a CXL controller configured to transmit/receive data to/from the memory expander connected with the root port. The root port and the CXL controller may correspond to each other and be paired.

The processor may be configured to identify a root port to which the memory expander is connected based on the recognition that the memory expander is connected to the root complex, and update the physical address space of the computing device based on the root port to which the memory expander is connected.

The processor may be configured to map the root port to which the memory expander is connected to a physical address included in the physical address space of the computing device.

The processor may be configured to generate a memory request. The root complex may be configured to access a memory expander corresponding to a physical address of the memory request through the updated physical address space, based on the memory request.

The root complex may be configured to identify the memory expander corresponding to the physical address of the memory request on the updated physical address space, based on the memory request.

The root complex may be configured to transmit the memory request to the root port connected with the memory expander corresponding to the physical address of the memory request, based on the identifying.

The root port connected with the memory expander corresponding to the physical address of the memory request may be configured to convert the memory request into a CXL protocol message. The CXL controller may be configured to transmit the CXL protocol message to the memory expander corresponding to the physical address of the memory request.

According to an aspect, there is provided a computing device including a processor, a memory, and a root complex configured to be connected with the processor, the memory, and a plurality of memory expanders. The processor may be configured to recognize whether each of the plurality of memory expanders is connected to the root complex, and update a physical address space of the computing device based on a recognition that each of the plurality of memory expanders is connected to the root complex. The root complex may be configured to access a memory expander corresponding to a physical address of a memory request among the plurality of expanders through the updated physical address space, based on the memory request.

The root complex may be configured to connect the processor, the memory, and the plurality of memory expanders through a CXL protocol-based interconnect.

The root complex may include a plurality of root parts configured to be connected to the plurality of memory expanders, respectively, and a plurality of CXL controllers configured to transmit/receive data to/from memory expanders connected with the plurality of root parts, respectively. The plurality of root parts and the plurality of CXL controllers may correspond to each other one by one and be paired.

The root complex may be configured to identify a memory expander corresponding to the physical address of the memory request on the updated physical address space, based on the memory request.

The root complex may be configured to transmit the memory request to a root port connected with the memory expander corresponding to the physical address of the memory request, in response to the identifying.

The root port connected with the memory expander corresponding to the memory request may be configured to transform the memory request into a CXL protocol message. The CXL controller may be configured to transmit the CXL protocol message to the memory expander corresponding to the memory request.

According to an aspect, there is provided an operating method of a computing device including recognizing whether a memory expander is connected to a root complex, and updating a physical address space of the computing device based on a recognition that the memory expander is connected to the root complex. The root complex may be configured to be connected with a processor, a memory, and the memory expander.

The root complex may be configured to connect the processor, the memory, and the memory expander through a CXL protocol-based interconnect.

The root complex may include a root port configured to be connected with the memory expander, and a CXL controller configured to transmit/receive data to/from the memory expander connected with the root port. The root port and the CXL controller may correspond to each other and be paired.

The updating of the physical address space of the computing device may include identifying a root port to which the memory expander is connected based on the recognition that the memory expander is connected to the root complex, and updating the physical address space of the computing device based on the root port to which the memory expander is connected.

The updating of the physical address space of the computing device based on the root port to which the memory expander is connected may include mapping the root port to which the memory expander is connected to a physical address included in the physical address space of the computing device.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of a computing system according to an embodiment;

FIG. 2 illustrates an example of a computing device and a memory expander according to an embodiment;

FIG. 3 illustrates an example of a root complex shown in FIG. 2;

FIG. 4 illustrates an example of a compute express link (CXL) controller shown in FIG. 3;

FIG. 5 is a diagram illustrating an operation of updating a physical address space of a computing device according to an embodiment;

FIG. 6 is a flowchart illustrating an example of an operating method of a computing device according to an embodiment; and

FIG. 7 illustrates an example of a computing device according to an embodiment;

### DETAILED DESCRIPTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components, and any repeated description related thereto will be omitted.

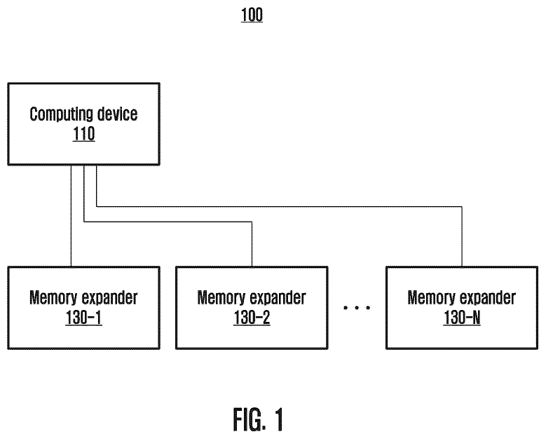

FIG. 1 illustrates an example of a computing system according to an embodiment.

Referring to FIG. 1, a computing system 100 may include a computing device 110 and a plurality of memory expanders (e.g., 130-1 to 130-N). However, FIG. 1 merely shows an example to carry out the present disclosure, and the scope of the present disclosure is not limited thereto. For example, rather than a plurality of memory expanders, a single memory expander (e.g., one of the memory expanders 130-1 to 130-N) may be provided.

Hereinafter, for ease of description, the description will be provided based on the memory expander 130-1. However, the description of the memory expander 130-1 may substantially identically apply to the memory expanders 130-2 to 130-N.

The memory expander 130-1 may be implemented as an endpoint device generally not including an arithmetic unit (e.g., an arithmetic logic unit (ALU)) and a cache (e.g., a cache storing data used by the arithmetic unit. However, embodiments are not limited thereto, and the memory expander 130-1 may also be implemented an endpoint device including an arithmetic unit and a cache (e.g., an accelerator (e.g., a graphics processing unit (GPU), a neural processing unit (NPU), and/or a tensor processing unit (TPU)).

The computing device 110 may access the memory expander 130-1 through a compute express link (CXL) interconnect. The CXL interconnect may refer to an interconnect technique for connecting various types of peripheral devices (e.g., the memory expanders 130-1 to 130-N) through peripheral component interconnect express (PCIe). The CXL interconnect may guarantee cache coherence between the computing device 110 and the plurality of memory expanders 130-1 to 130-N. The CXL interconnect may connect heterogeneous devices (e.g., the plurality of memory expanders 130-1 to 130-N) based on an asynchronous communication protocol (e.g., a CXL protocol).

The CXL protocol may include a CXL.mem protocol, a CXL.io protocol, and a CXL.cache protocol. The CXL.mem protocol may cause data stored in a memory in the memory expander 130-1 to be stored in a cache in the computing device 110. The CXL.io protocol may cause initialization such as device enumeration and/or CXL Flit-based non-coherent input/output (I/O) communication to be performed. The CXL.cache protocol may cause data stored in a local memory of the computing device 110 to be stored in a cache in the memory expander 130-1 (e.g., an endpoint device including an arithmetic unit and a cache), guaranteeing cache coherence between the computing device 110 and the endpoint device including the arithmetic unit and the cache.

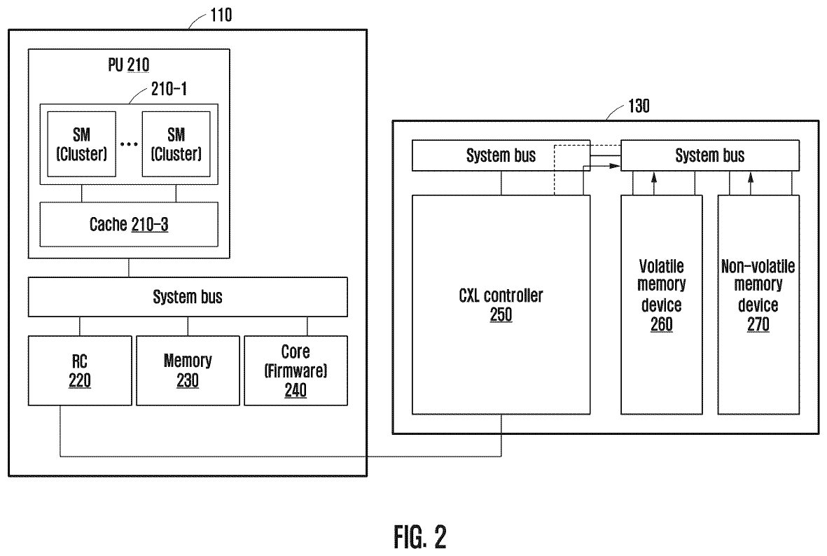

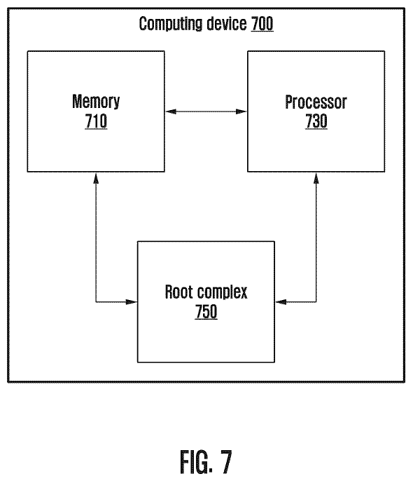

The computing device 110 may be implemented as a GPU, an NPU, and/or a TPU, but is not limited thereto. For example, the computing device 110 may be implemented as an accelerator including the components shown in FIG. 2 and/or FIG. 7.

The computing device 110 may access the memory expander 130-1 and use the memory of the memory expander 130-1. For example, the computing device 110 may integrate the memory space of the memory expander 130-1 into the memory space of the computing device 110. The detailed configuration and operation of the computing device 110 and/or the memory expander 130-1 will be described in detail with reference to FIG. 2.

FIG. 2 illustrates an example of a computing device and a memory expander shown in FIG. 1.

Referring to FIG. 2, the computing device 110 may include a processing unit (PU) 210, a root complex (RC) 220, a memory 230, and a core 240. However, FIG. 2 merely shows an example to describe the present disclosure, and the scope of the present disclosure should not be interpreted as being limited thereto. For example, the PU 210 and the core 240 may be implemented as a single processor (not shown). That is, the operation of the PU 210 and the operation of the core 240 may be performed by the single processor. Hereinafter, for ease of description, the operation of the PU 210 and the operation of the core 240 will be described separately.

The core 240 may recognize whether a memory expander 130 (e.g., the memory expanders 130-1 to 130-N of FIG. 1) is connected to the RC 220. The core 240 may update a physical address space of the computing device 110 based on a recognition that the memory expander 130 is connected to the RC 220. Updating the physical address space of the computing device 110 may refer to integrating a physical address space of the memory expander 130 into the physical address space of the computing device 110. For example, the core 240 may assign the physical address space of the memory expander 130 to a physical address included in the physical address space of the computing device 110. As another example, the core 240 may map the physical address included in the physical address space of the computing device 110 and a root port to which the memory expander 130 is connected. The updated physical address space may include a mapping result (e.g., a result of mapping the root port to which the memory expander 130 is connected to the physical address included in the computing device 110). The mapping result may be represented in Table 1 below.

TABLE 1

| Physical address of computing device | Root port |
|---|---|
| 0x00-0x1F | 1 |
| 0x20-0x3F | 2 |
| 0x40-0x7F | 3 |

. . .

Table 1 shows the mapping between physical addresses of the computing device 110 and root ports to which the memory expander 130 is connected as a lookup table.

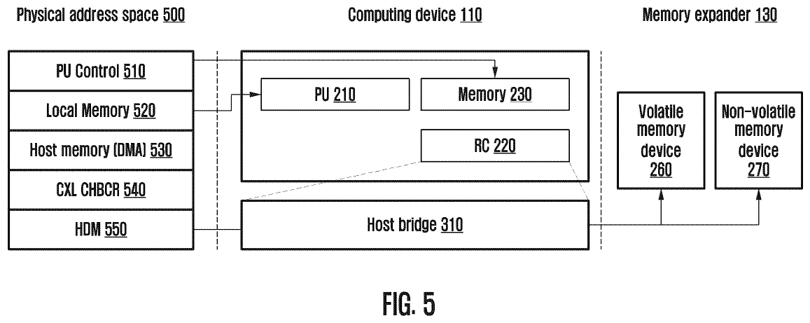

A detailed operation of updating the physical address space of the computing device 110 will be described in detail with reference to FIG. 5. Hereinafter, it will be described on the premise that the physical address space of the computing device 110 is updated.

The PU 210 may include a streaming multiprocessor (SM) cluster 210-1 and a cache 210-3. The SM cluster 210-1 may perform a variety of operation processing. The SM cluster 210-1 may include a compute unified device architecture (CUDA) core (not shown) and a cache (e.g., a level 2 (L2) cache) (not shown) to perform a variety of operation processing. The cache 210-3 may serve as a global cache for the PU 210. The cache 210-3 may be a higher-level cache than the cache (not shown) included in the SM cluster 210-1. The cache 210-3 may provide data more quickly to the SM cluster 210-1 if a cache miss occurs in the cache included in the SM cluster 210-1.

The SM cluster 210-1 may output a memory request to request data required for operation processing. For example, the SM cluster 210-1 may output the memory request if the data required for operation processing is not in the cache (e.g., the cache (not shown) included in the SM cluster 210-1 and/or the cache 210-3). The memory request may be transmitted to the RC 220 through a system bus.

The RC 220 may connect the processor (e.g., including the PU 210 and/or the core 240), the memory 230, and the memory expander 130 through a CXL protocol-based interconnect (e.g., a CXL interconnect). Since the CXL interconnect has been described in detail with reference to FIG. 1, the description will be omitted hereinafter.

The RC 220 may include a root port to be connected with the memory expander 130, and a CXL controller to transmit/receive data to/from the memory expander 130 connected with the root port. The root port and the CXL controller may correspond to each other and be paired.

The RC 220 may obtain (e.g., receive) the memory request from the PU 210 through the system bus. The RC 220 may access the memory expander 130 corresponding to the memory request through the updated physical address space, based on the memory request. For example, the RC 220 may identify the memory expander 130 corresponding to the memory request on the updated physical address space, based on the memory request. When the memory expander 130 corresponding to the memory request is identified, the RC 220 may transmit the memory request to the root port connected with the memory expander 130.

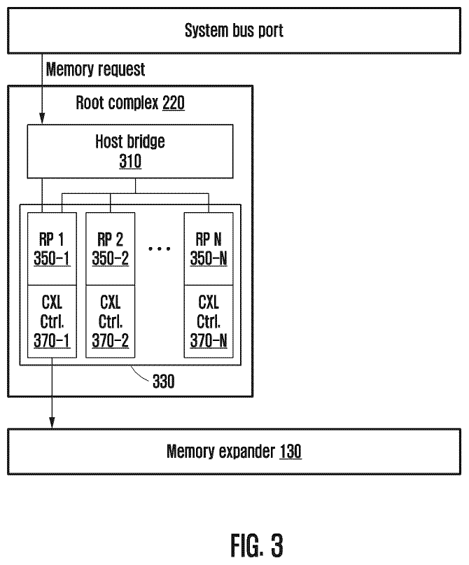

The RC 220 may process the memory request obtained (e.g., received) from the PU 210 and transmit the processed memory request to the memory expander 130 corresponding to the memory request. The memory expander 130 corresponding to the memory request may include the memory expander 130 storing data about the memory request (e.g., data required for operation processing requested through the memory request. The detailed configuration and operation of the RC 220 will be described in detail with reference to FIG. 3.

The memory 230 may be implemented as a volatile memory device and/or a non-volatile memory device. The memory 230 is a memory of the computing device 110, and the physical address space of the memory expander 130 may be integrated into the physical address space of the computing device 110, to expand the capacity of the memory 230.

The memory expander 130 may include a CXL controller 250, a volatile memory device 260, and a non-volatile memory device 270. However, an example of implementing the memory expander 130 is not limited thereto, and the memory expander 130 may include only one of the volatile memory device 260 and the non-volatile memory device 270.

The CXL controller 250 may be connected with the RC 220 through a CXL interface. The CXL controller 250 may obtain (e.g., receive) the processed memory request from the RC 220. The CXL controller 250 may obtain data about the memory request from the volatile memory device 260 and/or the non-volatile memory device 270, based on the processed memory request. The CXL controller 250 may output the data about the memory request to the computing device 110.

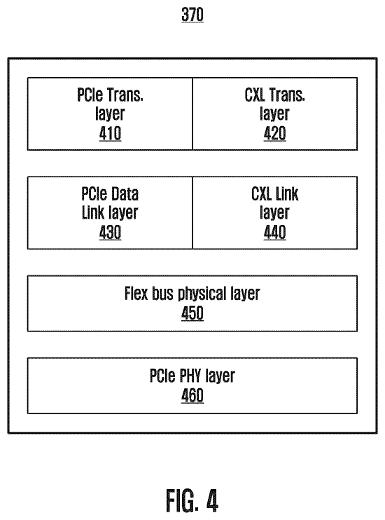

The CXL controller 250 may be implemented in the same manner as a CXL controller (not shown) included in the RC 220. The detailed configuration of the CXL controller included in the RC 220 will be described in detail with reference to FIG. 4.

FIG. 3 illustrates an example of a root complex shown in FIG. 2.

Referring to FIG. 3, the RC 220 may include a host bridge 310, a plurality of root parts (e.g., RP 1 350-1 to RP N 350-N), and a plurality of CXL controllers (e.g., CXL Ctrl 370-1 to CXL Ctrl 370-N).

The plurality of root parts and the plurality of CXL controllers may correspond to each other one by one and be paired. RP and CXL Ctrl having the same index may be paired with each other. For example, RP 1 350-1 and CXL Ctrl 370-1 are paired.

One root port may be connected with one memory expander. However, embodiments are not limited thereto, and the plurality of memory expanders 130-1 to 130-N may be connected to RP 1 350-1. For example, one RP 1 350-1 may be connected with the plurality of memory expanders 130-1 to 130-N through a CXL switch.

Hereinafter, for ease of description, it will be described on the premise that a memory expander and a root port having the same index are connected with each other. For example, RP 1 350-1 may be connected with the memory expander 130-1.

The host bridge 310 may manage a physical address space of a memory (e.g., the memory 230 of FIG. 2). When the physical address space of the memory 230 is updated by a core (e.g., the core 240 of FIG. 2), the host bridge 310 may manage the updated physical address space. Hereinafter, for ease of description, it may be premised that physical addresses of the memory 230 are mapped by the core 240 to root ports (e.g., RP 1 350-1 to RP N 350-N) to which the memory expanders 130-1 to 130-N are connected, as shown in Table 1.

The host bridge 310 may be connected to the plurality of root parts (e.g., RP 1 350-1 to RP N 350-N).

The host bridge 310 may communicate with a PU (e.g., the PU 210 of FIG. 2) through a system bus. For example, the host bridge 310 may obtain (e.g., receive) a memory request from the PU 210 through the system bus.

The host bridge 310 may identify a memory expander (e.g., the memory expanders 130-1 to 130-N of FIG. 1 and/or the memory expander 130 of FIG. 2) on the updated physical address space, based on the memory request. The updated physical address space may include information regarding which root ports (e.g., RP 1 350-1 to RP N 350-N) the memory expanders 130-1 to 130-N are connected to. For example, the host bridge 310 may identify a root port (e.g., RP 1 350-1) corresponding to the memory request, based on a physical address (e.g., 0x00-0x1F of Table 1) included in the memory request. The host bridge 310 may identify the memory expander 130-1 corresponding to the memory request, based on an index of the identified root port (e.g., RP 1 350-1).

When the memory expander 130-1 is identified, the host bridge 310 may transmit the memory request to the root ports (e.g., RP 1 350-1 to RP 1 350-N) connected with the memory expanders 130-1 to 130-N in response to the identification. For example, when the memory expander 130-1 is identified to correspond to the memory request, the host bridge 310 may transmit the memory request to RP 1 350-1 to which the memory expander 130-1 is connected.

The root port (e.g., RP 1 350-1) connected with the memory expander 130-1 corresponding to the memory request may convert the memory request into a CXL protocol message. A CXL controller (e.g., CXL Ctrl 370-1) paired with the root port (e.g., the root port (e.g., RP 1 350-1) connected with the memory expander 130-1 corresponding to the memory request) may transmit the CXL protocol message to the memory expander 130-1 corresponding to the memory request. For example, RP 1 350-1 may convert the memory request into a protocol message to transmit the memory request to the memory expander 130-1. CXL Ctrl 370-1 may transmit the protocol message to the memory expander 130-1.

FIG. 4 illustrates an example of a CXL controller shown in FIG. 3.

Referring to FIG. 4, a CXL controller 370 (e.g., CXL Ctrl 370-1 to CXL Ctrl 370-N of FIG. 3 and/or the CXL controller 250 of FIG. 2) may include a Peripheral Component Interconnect Express (PCIe) transaction layer 410, a CXL transaction layer 420, a PCIe link layer 430, a CXL link layer 440, a flex bus physical layer 450, and a PCIe PHY layer 460.

PCIe may refer to a computer interface having relatively high and variable latency, which can limit usability in connecting to memory.

A CXL interface is an open industrial standard that is fixed and provides a protocol to ensure cache coherence between devices connected based on PCIe, and as a result, may provide a relatively high bandwidth and relatively low fixed latency.

The CXL controller 370 may be appropriate to be connected to a memory (e.g., the memory 230, the volatile memory device 260, and/or the non-volatile memory device 270 of FIG. 2). The CXL controller 370 may be used further to provide connection between the computing device 110, a plurality of memory expanders (e.g., 130-1 to 130-N), and network interface circuits (“network interface controllers” or “network interface cards (NICs)”) in a server.

The CXL controller 370 may provide a CXL protocol, and the CXL protocol may be used for heterogeneous processing in vectors and buffered memory systems. To provide a cache-coherent interface, the CXL controller 370 may include a plurality of layers (e.g., the PCIe transaction layer 410, the CXL transaction layer 420, the PCIe link layer 430, the CXL link layer 440, the flex bus physical layer 450, and the PCIe PHY layer 460). Hereinafter, the layers will be described.

The PCIe transaction layer 410 may be a logical layer in data transmission, and may format and interpret data into packets. For example, the PCIe transaction layer 410 may generate and interpret data packets. The PCIe transaction layer 410 may control the flow (and/or movement) of data packets by designating the address of the data packets.

The CXL transaction layer 420 may support cache coherence and high-performance data transmission by processing CXL-dedicated transactions. The CXL transaction layer 420 may support CXL protocol-based transactions to maintain cache coherence.

The PCIe link layer 430 may serve as an intermediary between a physical layer (e.g., the flex bus physical layer 450 and/or the PCIe PHY layer 460) and a transaction layer (e.g., the PCIe transaction layer 410 and/or the CXL transaction layer 420). The PCIe link layer 430 may manage the integrity and flow of data transmission (e.g., detect and correct errors in data occurring during transmission).

The CXL link layer 440 may be a CXL-dedicated link layer, and may manage efficient transmission of the CXL transaction layer 420. For example, the CXL link layer 440 may convert a CXL protocol message into a CXL flit format and transmit the same. As another example, the CXL link layer 440 may detect errors and/or data framing of the CXL transaction layer 420. As still another example, the CXL link layer 440 may manage a link for the CXL protocol.

The flex bus physical layer 450 may include a layer for managing physical signal transmission. For example, the flex bus physical layer 450 may manage physical signal transmission based on the CXL Flit length of a physical signal. The flex bus physical layer 450 may manage physical signals having different CXL Flit lengths using different schemes.

The PCIe PHY layer 460 may be a physical layer of a PCIe protocol, and may transmit a signal of a PCIe link.

FIG. 5 is a diagram illustrating an operation of updating a physical address space of a computing device according to an embodiment.

Referring to FIG. 5, a physical address space 500 is a diagram of the physical address space of the computing device 110. The physical address space 500 may be a physical address space of memories accessible by the computing device 110. The physical address space 500 may include a PU control space 510, a local memory space 520, a host memory space 530, a CXL host bridge control register (CHBCR) space 540, and an HDM space 550.

The PU control space 510 may be a space representing a register that controls the PU 210. For example, the computing device 110 may control the PU 210 based on data stored at a physical address of the register represented in the PU control space 510.

The local memory space 520 may be a physical address space representing data stored in the memory 230. The local memory space 520 and/or the HDM space 550 may be a physical address space representing data cached in a cache (e.g., the cache 210-3 of FIG. 2). For example, data stored in the local memory space 520 and/or the HDM space 550 may be data cached in the cache 210-3.

The host memory space 530 may be a physical address space mapped to a partial physical address space of a host (e.g., a CPU) if the host is present. In FIG. 5, the host is not shown separately to clarify that the computing device 110 can access the memory expander 130 without the intervention of the host.

The CXL CHBCR space 540 may be a physical address space representing a register that controls (e.g., reads or writes data from or to) the memory 230 through an external CXL interface.

The PU control space 510, the local memory space 520, the host memory space 530, and the CXL CHBCR space 540 may be intrinsic physical address spaces of the computing device 110 unrelated to the memory expander 130. Hereinafter, a method of updating the physical address space of the computing device 110 as the memory expander 130 is connected will be described.

A core (e.g., the core 240 of FIG. 2) may recognize whether the memory expander 130 is connected to the RC 220. The core 240 may update the physical address space 500 of the computing device 110 based on a recognition that the memory expander 130 is connected to the RC 220. The core 240 may integrate the physical address space of the memory expander 130 (e.g., the HDM space 550) into the physical address space 500.

The core 240 may verify a root port to which the memory expander 130 is connected, based on the recognition that the memory expander 130 is connected to the RC 220. For example, when the memory expander 130-1 is connected, the core 240 may determine that the memory expander 130-1 is connected to RP 1 (e.g., RP 1 350-1 of FIG. 3).

The core 240 may update the physical address space 500 of the computing device 110 based on the root port to which the memory expander 130 is connected. Through the update of the physical address space 500, the HDM space 550 may be generated. The core 240 may map the root port of the memory expander 130 to a predetermined physical address included in the physical address space 500. Accordingly, the physical address space of the memory expander 130 may be mapped to the physical address space 500 of the computing device 110. This has been described based on Table 1 with reference to FIG. 2, and thus, the description will not be repeated.

The HDM space 550 may include a mapping result (e.g., a result of mapping the root port to which the memory expander 130 is connected to a physical address). The HDM space 550 may be managed by the host bridge 310. The host bridge 310 may identify the memory expander 130 corresponding to a memory request through the mapping result included in the HDM space 550, based on the memory request.

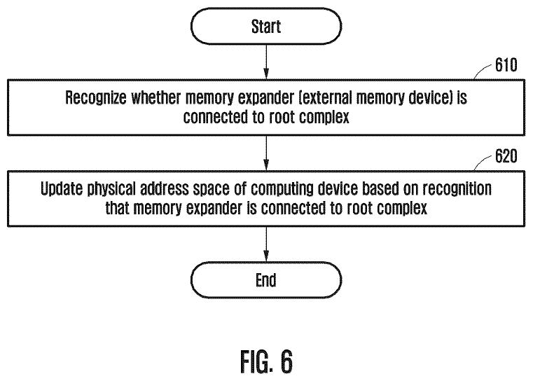

FIG. 6 is a flowchart illustrating an example of an operating method of a computing device according to an embodiment.

Referring to FIG. 6, operations 610 and 620 may be performed sequentially, but embodiments are not limited thereto. For example, the two operations may be performed in parallel. Operations 610 and 620 may be substantially the same as the operation of the computing device (e.g., the computing device 110 of FIG. 1) described with reference to FIGS. 1 to 5. Accordingly, a detailed description thereof will be omitted.

In operation 610, the computing device 110 may recognize whether the memory expander 130 is connected to a root complex (e.g., the RC 220 of FIG. 2).

In operation 620, the computing device 110 may update the physical address space of the computing device 110 based on a recognition that the memory expander (e.g., the memory expanders 130-1 to 130-N of FIG. 1) is connected to the RC 220.

FIG. 7 illustrates an example of a computing device according to an embodiment.

A computing device 700 may include a memory 710 (e.g., the memory 230 of FIG. 2), a processor 730 (e.g., the PU 210 and/or the core 240 of FIG. 2), and a root complex 750 (e.g., the RC 220 of FIG. 2). The computing device 700 may include the computing device 110 of FIG. 1.

The memory 710 may store instructions (e.g., a program) executable by the processor 730. For example, the instructions may include instructions for executing the operation of the processor 730 and/or the operation of each component of the processor 730.

The memory 710 may be implemented as volatile memory or non-volatile memory.

The volatile memory may be implemented as a dynamic random-access memory (DRAM), a static random-access memory (SRAM), a thyristor RAM (T-RAM), a zero capacitor RAM (Z-RAM), or a twin transistor RAM (TTRAM).

The non-volatile memory may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate Memory (NFGM), a holographic memory, a molecular electronic memory device), or an insulator resistance change memory.

The processor 730 may process data stored in the memory 710. The processor 730 may execute computer-readable code (e.g., software) stored in the memory 710 and instructions triggered by the processor 730.

The processor 730 may be a hardware-implemented data processing device having a circuit that is physically structured to execute desired operations. The desired operations may include, for example, code or instructions included in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The root complex 750 may perform the operations performed by the RC 220 of FIG. 2 substantially identically. The description thereof will not be repeated.

The processor 730 may execute the code and/or instructions stored in the memory 710, thereby causing the computing device 700 to perform one or more operations. The operations performed by the computing device 700 may be substantially the same as those performed by the computing device 110 described with reference to FIGS. 1 to 6. The description thereof will not be repeated.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

A number of embodiments have been described above. Nevertheless, it should be understood that various modifications may be made to these embodiments. For example, suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

What is claimed is:

1. A computing device comprising:
a processor;
a memory; and
a root complex configured to be connected with the processor, the memory, and a memory expander,
wherein the processor is configured to:
recognize whether the memory expander is connected to the root complex, and
update a physical address space of the computing device based on a recognition that the memory expander is connected to the root complex.

2. The computing device of claim 1, wherein the root complex is configured to connect the processor, the memory, and the memory expander through a compute express link (CXL) protocol-based interconnect.

3. The computing device of claim 1, wherein
the root complex comprises:
a root port configured to be connected with the memory expander; and
a CXL controller configured to transmit/receive data to/from the memory expander connected with the root port, and
the root port and the CXL controller correspond to each other and are paired.

4. The computing device of claim 3, wherein the processor is configured to:
identify a root port to which the memory expander is connected based on the recognition that the memory expander is connected to the root complex, and
update the physical address space of the computing device based on the root port to which the memory expander is connected.

5. The computing device of claim 4, wherein the processor is configured to map the root port to which the memory expander is connected to a physical address included in the physical address space of the computing device.

6. The computing device of claim 3, wherein
the processor is configured to generate a memory request, and
the root complex is configured to access a memory expander corresponding to a physical address of the memory request through the updated physical address space, based on the memory request.

7. The computing device of claim 6, wherein the root complex is configured to identify the memory expander corresponding to the physical address of the memory request on the updated physical address space, based on the memory request.

8. The computing device of claim 7, wherein the root complex is configured to transmit the memory request to the root port connected with the memory expander corresponding to the physical address of the memory request, based on the identifying.

9. The computing device of claim 8, wherein
the root port connected with the memory expander corresponding to the physical address of the memory request is configured to convert the memory request into a CXL protocol message, and
the CXL controller is configured to transmit the CXL protocol message to the memory expander corresponding to the physical address of the memory request.

10. A computing device comprising:
a processor;
a memory; and
a root complex configured to be connected with the processor, the memory, and a plurality of memory expanders,
wherein the processor is configured to:
recognize whether each of the plurality of memory expanders is connected to the root complex, and
update a physical address space of the computing device based on a recognition that each of the plurality of memory expanders is connected to the root complex, and
the root complex is configured to access a memory expander corresponding to a physical address of a memory request among the plurality of expanders through the updated physical address space, based on the memory request.

11. The computing device of claim 10, wherein the root complex is configured to connect the processor, the memory, and the plurality of memory expanders through a compute express link (CXL) protocol-based interconnect.

12. The computing device of claim 10, wherein
the root complex comprises:
a plurality of root parts configured to be connected to the plurality of memory expanders, respectively; and
a plurality of CXL controllers configured to transmit/receive data to/from memory expanders connected with the plurality of root parts, respectively, and
the plurality of root parts and the plurality of CXL controllers correspond to each other one by one and are paired.

13. The computing device of claim 12, wherein the root complex is configured to identify a memory expander corresponding to the physical address of the memory request on the updated physical address space, based on the memory request.

14. The computing device of claim 13, wherein the root complex is configured to transmit the memory request to a root port connected with the memory expander corresponding to the physical address of the memory request, in response to the identifying.

15. The computing device of claim 14, wherein
the root port connected with the memory expander corresponding to the memory request is configured to transform the memory request into a CXL protocol message, and
the CXL controller is configured to transmit the CXL protocol message to the memory expander corresponding to the memory request.

16. An operating method of a computing device, the operating method comprising:
recognizing whether a memory expander is connected to a root complex; and
updating a physical address space of the computing device based on a recognition that the memory expander is connected to the root complex,
wherein the root complex is configured to be connected with a processor, a memory, and the memory expander.

17. The operating method of claim 16, wherein the root complex is configured to connect the processor, the memory, and the memory expander through a compute express link (CXL) protocol-based interconnect.

18. The operating method of claim 16, wherein
the root complex comprises:
a root port configured to be connected with the memory expander; and
a CXL controller configured to transmit/receive data to/from the memory expander connected with the root port, and
the root port and the CXL controller correspond to each other and are paired.

19. The operating method of claim 18, wherein the updating of the physical address space of the computing device comprises:
identifying a root port to which the memory expander is connected based on the recognition that the memory expander is connected to the root complex; and
updating the physical address space of the computing device based on the root port to which the memory expander is connected.

20. The operating method of claim 19, wherein the updating of the physical address space of the computing device based on the root port to which the memory expander is connected comprises mapping the root port to which the memory expander is connected to a physical address included in the physical address space of the computing device.
